(19) United States
(12) Patent Application Publication
(10) Pub. No.: US 2026/0289012 A1
(43) Pub. Date: Sep. 24, 2026

(54) METHOD AND SYSTEM FOR ANONYMIZED UE DATA EXPOSURE IN WIRELESS SYSTEMS

(71) Applicants: Centre of Excellence in Wireless Technology, Chennai (IN); Indian Institute of Technology Madras (IIT Madras), Chennai (IN)

(72) Inventors: Ankita Lachhwani, Chennai (IN); Vikram Krishnakumar, Chennai (IN); Anusuya Balasubramanian, Chennai (IN); Jeniston Deviraj Klutto Milleth, Chennai (IN); Bhaskar Ramamurthi, Chennai (IN)

(21) Appl. No.: 19/533,076

(22) Filed: Feb. 6, 2026

(30) Foreign Application Priority Data
Feb. 7, 2025 (IN) 202541010348

(51) Int. Cl. G06F 21/62

(52) U.S. Cl. CPC G06F 21/6254

(57) ABSTRACT

The present invention provides a method for anonymized exposure of user equipment (UE) information in a communication network. The method comprises receiving, by a node, a first request from a service consumer for UE anonymized data containing plurality of first attributes. Further, the method comprises selecting, by the node, at least one data producer, based on at least one attribute from the plurality of first attributes and by using a user plane entity, and sending, by the node, a second request containing the plurality of second attributes to the data producer. Further, the method includes receiving, by the node, from the data producer, at least one of a first response and at least one first notification containing the data of at least one UE, based on the plurality of second attributes, and processing, by the node, the data of at least one UE, based on the plurality of first attributes to generate a first report. The method further includes generating, by the node, a second report by anonymizing the UE identification information in the first report, and sending, by the node, the second report to the service consumer, based on at least one first attribute from the plurality of first attributes.

### TECHNICAL FIELD

The present disclosure, generally, relates to 5G core networks. More particularly, the present disclosure relates to a method and a system for anonymizing user equipment (UE) data exposure in wireless communication systems.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

A standard telecommunication network following 3GPP standards consists of four components namely the User Equipment (UE), Radio Access Network (RAN), the Core Network (CN) and Data Network (DN). A UE registered to a 5G network shall be allocated one of the UE identifiers—Subscription Permanent Identifier (SUPI)/Temporary Mobile Subscription Identifier (TMSI)/Generic Public Subscription Identifier (GPSI) based on the procedures UE is involved in. Typically, the activities of the UE within the network are monitored and mapped to its corresponding UE identifier by 5G-CN. External identifiers are mapped identity for the UE's internal identifier as those are sensitive information that should not be exposed outside.

The 5G Core Network (5G-CN) architecture has been designed to support a diverse array of services with unique requirements and is characterized by a decentralized structure where each network function (NF) offers a different set of functionalities.

Exposure is one of the key functionalities introduced in 5G offered by 5G-CN NF, Network Exposure Function (NEF). NEF performs gateway functionality for external Application Function (AF) to avail services from 5G-CN after prior authorization and authentication based on operator policies. Apart from this, it is also responsible for translation of external information from external AF to internal information that other NFs can understand and vice versa. External exposure is categorized as Monitoring capability, Provisioning capability, Policy/Charging capability, Analytics reporting capability and Member User Equipment (UE) selection capability. Currently the exposure request is for a specific UE/group of UEs where the authorized external AF could request for a single or multiple events from the network. In certain scenarios, the information could be exposed as trends or statistics across multiple UEs.

There are various use cases where any of these UE identities are not required to be exposed by still valuable information such as trends could be utilized by AF. For example, the populace and movement trend of UEs in a specified zone/Range could be helpful for monetization such as advertisement or security/manpower planning. Similarly, UEs Access Split Range/Percentage, Data/QoS/Slice utilization efficiency would be helpful for network optimization and planning. Again, the number of users and tracking their movement in an area, UE Accessibility could be helpful in public safety such as evacuation or emergency information broadcasting.

The NEF in 5G-CN acts as a gateway for an external AF by exposing appropriate information of UE(s) based on operator policies. It translates the request from an external AF and forwards it to the respective NF depending upon the type of service requested. Prior to obtaining services, the external AF is authenticated and authorized by NEF. The external AF subscribes to NEF to receive response and notifications for the same. The exposure is majorly classified as monitoring capability, provisioning capability, policy/charging capability, analytics reporting capability and member user equipment (UE) selection capability. Monitoring capability is comprised of means that allow the identification of the 5G NF suitable for handling specific monitoring events, detect the monitoring event, and report the monitoring event information to the external AF. Currently, the AF requests or subscribes to monitoring information for a specific or group of UE(s). The NEF handles the authorization and authentication of the AF. User consent is required for exposing sensitive UE information to the external AF.

The current exposure of UE information includes UE identity either in AF request which is for a specific UE/group of UEs, or the event response would contain the list of UE identities for which the AF has subscribed for. These constraints acts as a bottleneck, where only events of limited UE(s) could be reported to external AF. There are various use cases where the UE identity is not required by the AF. This information could be utilized by AF for monetization, network planning and optimization, survey for trends, public safety etc. Currently, there is no mechanism at the NEF to expose UE data to external AF anonymously by masking the UE identities. Also, there is no mechanism to collect information from Data Centres which could be exposed to the external AF or shared to OAM for monetization and network optimization purposes. In such case, UE identities are not required to be exposed but consolidated, pre-processed information can be exposed by NEF to external AF as anonymized data using specific exposure service. The collected data could be further utilized by external AF/OAM for monetization, network planning and optimization, public safety etc.

Applicant has identified many technical challenges and difficulties associated with current solutions and through applied effort, ingenuity, and innovation, the applicant has provided a solution to the above-mentioned drawbacks.

### SUMMARY OF THE INVENTION

The summary is provided to introduce aspects related to a method and a system for anonymizing user equipment (UE) data exposure in wireless communication systems, and the aspects are further described below in the detailed description. This summary is not intended to identify essential features of the claimed subject matter nor is it intended for use in determining or limiting the scope of the claimed subject matter.

A method for anonymized exposure of user equipment (UE) information in a communication network is disclosed. The method comprises receiving, by a node, a first request from a service consumer for UE anonymized data containing plurality of first attributes. Further, the method comprises selecting, by the node, at least one data producer, based on at least one attribute from the plurality of first attributes and by using a user plane entity, and sending, by the node, a second request containing the plurality of second attributes to the data producer. Further, the method includes receiving, by the node, from the data producer, at least one of a first response and at least one first notification containing the data of at least one UE, based on the plurality of second attributes, and processing, by the node, the data of at least one UE, based on the plurality of first attributes to generate a first report. The method further includes generating, by the node, a second report by anonymizing the UE identification information in the first report, and sending, by the node, the second report to the service consumer, based on at least one first attribute from the plurality of first attributes.

In an embodiment, the method comprises sending the second report using one of a second response and at least one of a second notification.

In an embodiment, the method comprises receiving, by the node, further comprises selecting by the node, at least one UE based on the privacy policy and subscriber permission allowing anonymized data exposure, wherein the privacy policy and subscriber permission allowing anonymized data exposure of the at least one requested UE is obtained from a data repository entity in Core network.

In an embodiment, the node is a network exposure entity. Further, in another embodiment, the network exposure entity is a network function in the Core network.

In an embodiment, the service consumer is at least one external Application Function. Further, in an embodiment, the data producer is at least one of: an NF in Core network, Data Collection AF in Core network, an entity in the Radio access network (RAN), and Data Centre.

In an embodiment, wherein, when a data producer in the at least one data producer is a data centre, the method comprises performing selection by the node using the user plane entity.

In an embodiment, the first request, the second response and the second notification is using a service API. In a further embodiment, the service API is an anonymized exposure service API. In a further embodiment, the service API is implemented by enhancing Analytics API, Event exposure API of network exposure entity.

A method for anonymized exposure of user equipment (UE) information in a communication network is disclosed according to another aspect of the present invention. The method comprises receiving, by a data generator, a third request from a service consumer for UE anonymized data containing plurality of third attributes, and processing, by the data generator, the data of at least one UE, based on the plurality of third attributes to generate a third report. The method further includes generating, by the data generator, a fourth report by anonymizing the UE identification information in the third report, and sending, by the data generator, the fourth report to the service consumer, based on at least one third attribute from the plurality of third attributes.

In an embodiment, the method includes performing sending the fourth request using one of a third response and at least one of a third notification.

In an embodiment, the data generator comprises of NF, data collection AF in the Core network and data centre. In a further embodiment, the service consumer is Operations, Administration, and Maintenance entity (OAM).

In an embodiment, the third request, the third response and the third notification is sent using a service API.

In an embodiment, the service API is an anonymized exposure service API.

In an embodiment, the method includes anonymizing the UE identification information by performing masking of identification of the UE.

In an embodiment, at least one of the first attribute, the second attribute and the third attribute comprises of an event type and a reporting type. In an embodiment, the attribute event type includes value from any one of: populace and Movement Trend of UEs in a specified zone or range, data Utilization Efficiency, application Usage Trends, UEs Access Split Range/Percentage, radio Resource Utilization Efficiency, QoS Utilization Efficiency, slice Utilization Efficiency, slice Load Handling Efficiency, UE Accessibility, number of dropped Connections, and thermal Energy Exposure. In a further embodiment, the attribute reporting type is at least one of one-time, periodic, and event-triggered.

A node for implementing anonymized exposure of user equipment (UE) information in a communication network is disclosed. In an embodiment, the node is configured to receive a first request from a service consumer for UE anonymized data containing plurality of first attributes, select at least one data producer, based on at least one attribute from the plurality of first attributes and by using a user plane entity. The node is further configured to send a second request containing the plurality of second attributes to the data producer, and receive from the data producer, at least one of a first response and at least one first notification containing the data of at least one UE, based on the plurality of second attributes. Further, the node is configured to process the data of at least one UE, based on the plurality of first attributes to generate a first report, generate a second report by anonymizing the UE identification information in the first report, and send the second report to the service consumer, based on at least one first attribute from the plurality of first attributes.

In an embodiment, the node is configured to send the second report using one of a second response and at least one of a second notification.

In an embodiment, the node in, receiving, is further configured to select at least one UE based on the privacy policy and subscriber permission allowing anonymized data exposure.

In yet another embodiment, the node is configured to obtain the privacy policy and subscriber permission allowing anonymized data exposure of the at least one requested UE from a data repository entity in Core network.

In one embodiment, the node is a network exposure entity.

In another embodiment, the network exposure entity is a network function in the Core network.

In yet another embodiment, the service consumer is at least one external Application Function.

In an embodiment, the data producer is at least one of: an NF in Core network, Data Collection AF in Core network, an entity in the Radio access network (RAN), and Data Centre.

In an embodiment, the node is further configured to use the user plane entity to select data producer, when a data producer in the at least one data producer is a data centre.

In an embodiment, the first request, the second response and the second notification is using a service API. In one embodiment, the service API is an anonymized exposure service API. In another embodiment, the service API is implemented by enhancing Analytics API, Event exposure API of network exposure entity.

A node for implementing anonymized exposure of user equipment (UE) information in a communication network is disclosed in another aspect of the present invention. The node is configured to receive a third request from a service consumer for UE anonymized data containing plurality of third attributes, process the data of at least one UE, based on the plurality of third attributes to generate a third report, generate a fourth report by anonymizing the UE identification information in the third report, and send the fourth report to the service consumer, based on at least one third attribute from the plurality of third attributes.

In an embodiment, the node is a data generator which may comprises of NF, data collection AF in the Core network and data centre.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings are included to provide a further understanding of the present disclosure, and are incorporated in and constitute a part of this specification.

FIG. 1 depicts flow for external AF requesting for data from NEF and based on type of request, NEF forwarding the data to corresponding entity, according to an embodiment of the present invention;

FIG. 2 illustration a method for anonymized exposure of user equipment (UE) information in a communication network, according to an embodiment of the present invention;

FIG. 3 illustration a method for anonymized exposure of user equipment (UE) information in a communication network, according to another embodiment of the present invention;

FIG. 4 depicts flow for anonymized Exposure with data collected from NF/Data Collection AF, according to an embodiment of the present invention;

FIG. 5 depicts flow for anonymized Exposure with data collected from Data Centre(s), according to an embodiment of the present invention; and

FIG. 6 depicts flow for sharing anonymized data to OAM, according to an embodiment of the present invention.

The embodiments are illustrated by way of example and not by way of limitation in the figures of the accompanying drawings in which references indicate similar elements. It should be noted that references to “an” or “one” embodiment in this disclosure are not necessarily to the same embodiment, and they mean at least one in the drawings. A more complete understanding of the present invention and its embodiments thereof may be acquired by referring to the following description and the accompanying drawings.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention addresses the gap where the UE identity is present either in request from AF or as a response from the network. The concept of anonymized data service is proposed to provide UEs trends information without revealing UE identities to external AF. By defining new service in NEF for anonymized exposure but re-using the other internal services, the present invention proposes a new service in NEF, i.e., ensuring that the decision to provide UE identity information remains internal to the Core Network, enhancing security and privacy by providing isolation, and enabling easy scalability for future requirements.

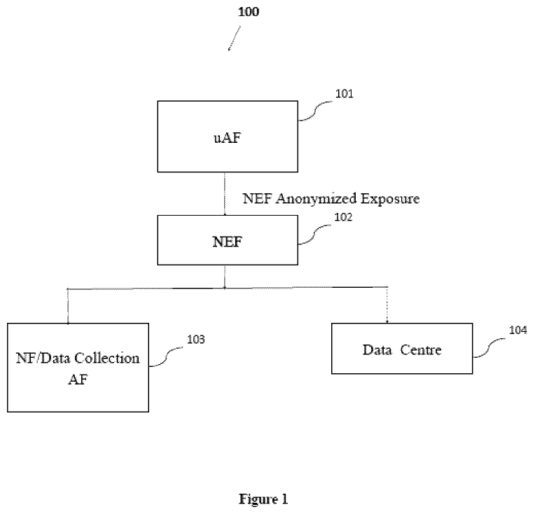

FIG. 1 depicts flow for external AF requesting for data from NEF and based on type of request, NEF forwarding the data to corresponding entity, according to an embodiment of the present invention. As illustrated, on service invocation by external AF i.e., uAF (101), NEF (102) collects data from NF(s) or data collection AF (103) in core network and exposes it to external AF i.e., uAF (101). The service flow may be categorized in two parts, i.e., (1) Anonymized Exposure with data collected from NF/Data Collection AF, (2) Anonymized Exposure with data collected from Data Centre through UPF. The present invention proposes to reuse the existing services wherever available from NF corresponding to event request or Data Collection request According to 3GPP TS 29.517, the data collection AF provides information about a group of UE(s) in a defined location as CollectiveBehaviourFilter. This would further reduce number of signaling transactions.

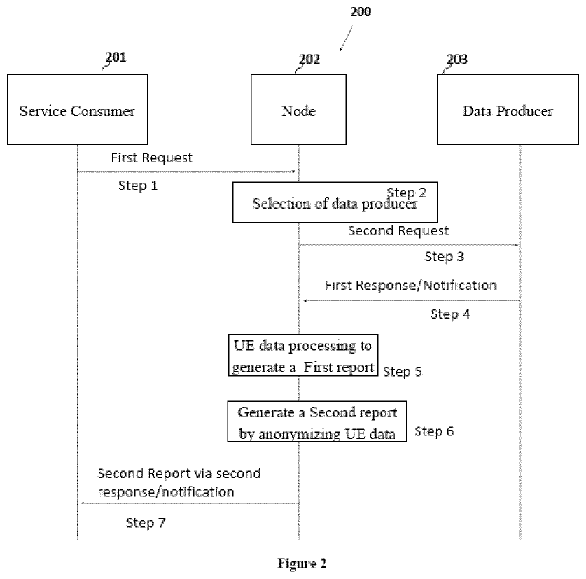

Operators hold vast amounts of data in data banks which could also be utilized for similar purposes. This data may be real time or non-real time information/analytics. The mechanism to collect this information from data centre(s) is disclosed. In this procedure, NEF would request the UPF to forward the exposure service request to appropriate Data Centre(s). UPF would translate the request based on requested Event Data type UPF maps it to the corresponding Data Centre(s). In an embodiment, OAM could also utilize this anonymized 5G system data for network optimization and planning. The OAM could directly communicate with appropriate entity to obtain system information. The system information includes data containing UE information. A more detailed embodiments and specific procedures are explained in reference to FIGS. 2 to 6 as below.

FIG. 2 illustrates a method for anonymized exposure of user equipment (UE) information in a communication network, according to an embodiment of the present invention.

In an exemplary embodiment, a communication network is illustrated which comprises of a service consumer 201, a node 202 and a data producer 203. In an embodiment, the service consumer 201 is at least one external Application Function. In another embodiment, the data producer 203 is at least one of: an NF in Core network, Data Collection AF in Core network, an entity in the Radio access network (RAN), and Data Centre. Further, in an embodiment, the node 202 is a network exposure entity, wherein the network exposure entity may be a network function in the Core network.

The flow chart illustrated in FIG. 2 illustrates method for anonymized exposure of user equipment (UE) information in a communication network. In Step 1, the node 202 receives a first request from a service consumer 201 for UE anonymized data containing plurality of first attributes. In an embodiment, the first attribute comprises of an event type and a reporting type. In an embodiment, the attribute event type includes value from any one of: populace and Movement Trend of UEs in a specified zone or range, data Utilization Efficiency, application Usage Trends, UEs Access Split Range/Percentage, radio Resource Utilization Efficiency, QoS Utilization Efficiency, slice Utilization Efficiency, slice Load Handling Efficiency, UE Accessibility, number of dropped Connections, and thermal Energy Exposure. Further, in an embodiment, the attribute reporting type is at least one of one-time, periodic, and event-triggered.

In the request from service consumer to node, multiple events may be requested with appropriate, attributes added for each of the specific event types. This request may contain but not limited to the following event types:

### LIST OF EVENTS

1. Event Type: Populace and Movement Trend of UEs in a specified zone/Range
Application: To track/estimate the number of UEs, movements in a particular area.
   1.1. For billboard advertisement in crowded areas
   1.2.To understand usage pattern/planning visits by users
   1.3. Planning manpower resources and security requirement in that area
   1.4.Evacuation in case of any emergency
2. Event Type: Data Utilization Efficiency
Application: To track efficient utilization of total data volume allocated
   2.1. For resource allocation and planning of Data Rates
3. Event Type: Application Usage Trends
Application: Start/Stop reporting for a specific application to analyze it usage both in spatial/temporal or both
   3.1. As feedback for the Application Developers to improve their service, perform better resource planning etc.
   3.2. Defining/Planning QoS/Slicing Requirements
4. Event Type: UEs Access Split Range/Percentage
Application: To analyze the trends for distribution of access usage in a particular area
   4.1.Network Optimization/Planning
5. Event Type: Radio Resource Utilization Efficiency Application: To track efficient utilization of total radio resources allocated
   5.1.Network Optimization/Planning
6. Event Type: QoS Utilization Efficiency
Application: To track efficient utilization of a particular QoS allocated/Service Experience by user
   6.1.Network Optimization/Planning
   6.2. Feedback for Service Experience by user
7. Event Type: Slice Utilization Efficiency
Application: To track efficient utilization of a particular slice allocated
   7.1.Network Optimization/Planning
8. Event Type: Slice Load Handling Efficiency
Application: To track how efficiently the load is distributed and handled on a specified slice
   8.1.Network Optimization/Planning
9. Event Type: Ue Accessibility
Application: To track how many UEs are accessible in a particular area.
   9.1.Useful for broadcast/emergency notification scheduling
10.Event Type: Number of dropped Connections
Application: To check the radio condition in a particular area
   10.1. Network Optimization/Planning
11. Event Type: Thermal Energy Exposure
Application: Thermal energy exposure in terms of heat radiated from UE(s) in an area can be exposed by Core network to external application and can help,
   11.1. The local government body or private agencies to understand how the UEs in a specific area contributes to Carbon footprint
   11.2. UE manufacturers/Mobile phone chipset developers to incorporate this information to improve product quality.

In Step 2, the node selects at least one data producer 203, based on at least one attribute from the plurality of first attributes and by using a user plane entity. In an embodiment, the data producer 203 is at least one of: an NF in Core network, Data Collection AF in Core network, an entity in the Radio access network (RAN), and Data Centre. When the data producer is the data centre, the node selects the data producer using the user plane entity.

In Step 3, the node sends a second request containing the plurality of second attributes to the data producer. In an embodiment, the second attributes may correspond to events identified in the first attributes.

In Step 4, the node 202 receives from the data producer 203, at least one of a first response and at least one first notification containing the data of at least one UE, based on the plurality of second attributes. In this step, the node is configured to select at least one UE data based on the privacy policy and subscriber permission allowing anonymized data exposure, wherein the privacy policy and subscriber permission allowing anonymized data exposure of the at least one requested UE is obtained from a data repository entity in the core network.

In Step 5, the node 202 processes the first response containing the date of at least one UE based on the plurality of first attributes to generate a first report.

In Step 6, the node 202 generates a second report by anonymizing the UE identification information in the first report.

In Step 7, the node 202 sends the second report to the service consumer 201, based on at least one first attribute from the plurality of first attributes. In an embodiment, the second report is sent using one of a second response and at least one of a second notification.

In an embodiment, the first request, the second response and the second notification is sent using a service API. In a further embodiment, the service API is an anonymized exposure service API. In another implementation, the service API is implemented by enhancing existing Analytics API, Event exposure API of network exposure entity.

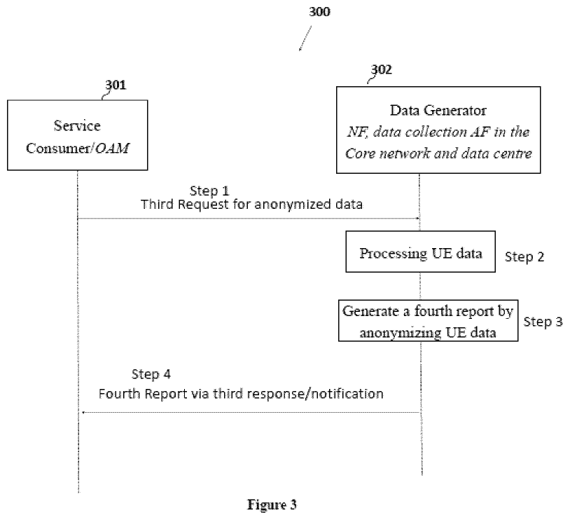

FIG. 3 illustration a method for anonymized exposure of user equipment (UE) information in a communication network, according to another embodiment of the present invention. In an exemplary embodiment, a communication network 300 is illustrated which comprises of a service consumer 301 and a data generator 302. In an embodiment, the data generator 302 comprises of NF, data collection AF in the Core network and data centre. In another embodiment, the service consumer 301 comprises Operations, Administration, and Maintenance entity (OAM).

The flow chart illustrated in FIG. 3 illustrates method for anonymized exposure of user equipment (UE) information in a communication network. In Step 1, the data generator 302 receives a third request from a service consumer 301 for UE anonymized data containing plurality of third attributes. In an embodiment, the third attribute comprises of an event type and a reporting type. In an embodiment, the attribute event type includes value from any one of: populace and Movement Trend of UEs in a specified zone or range, data Utilization Efficiency, application Usage Trends, UEs Access Split Range/Percentage, radio Resource Utilization Efficiency, QoS Utilization Efficiency, slice Utilization Efficiency, slice Load Handling Efficiency, UE Accessibility, number of dropped Connections, and thermal Energy Exposure. Further, in an embodiment, the attribute reporting type is at least one of one-time, periodic, and event-triggered.

In Step 2, the data generator 302 processes the data of at least one UE, based on the plurality of third attributes to generate a third report.

In Step 3, the data generator 302 generates a fourth report by anonymizing the UE identification information in the third report. In an embodiment, anonymizing the UE identification information is performed by masking identification of the UE.

In Step 4, the data generator 302 sends the fourth report to the service consumer, based on at least one third attribute from the plurality of third attributes. In an embodiment, the data generator 302 sends the fourth report using one of a third response and at least one of a third notification. In an embodiment, the third request, the third response and the third notification is sent using a service API.

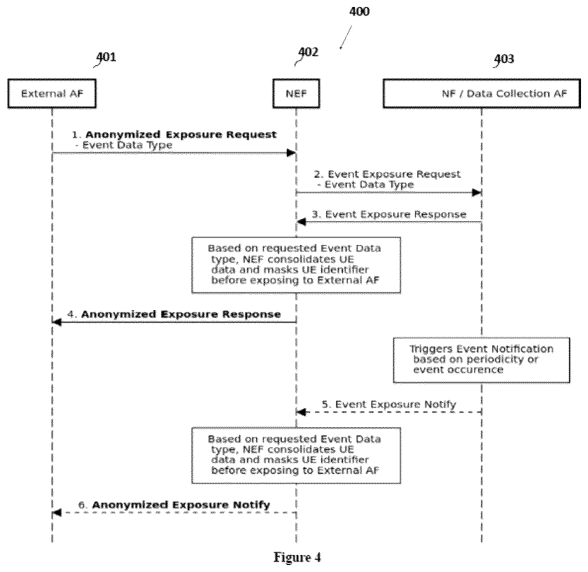

FIG. 4 depicts flow for anonymized Exposure with data collected from NF/Data Collection AF, according to an embodiment of the present invention. The steps as illustrated below in reference to FIG. 4 provides the procedure for the anonymized exposure request from AF (401) to corresponding entity NF/Data Collection AF (403) through NEF (402). The requested reporting type may be periodic, and event based the notification from corresponding entity is also explained below.

In Step 1, the external AF (401) will request anonymized UE data mentioning the event data type by invoking Anonymized Exposure service request to NEF (402) and creates a subscription. The reporting type can be either one time, periodic or event based.

In Step 2, NEF (402) translates this request to NF(s) (403). Depending on the requested event data type, NEF (402) invokes the service API of an appropriate NF data producer(s) within the 5G-CN, which can provide that requested information. The NEF (402) will create a subscription with that NF data producer(s) for the requested event depending on the subscription requested by external AF.

In Step 3, in the response, the NF data producer(s) (403) will include the UE data in the response to the NEF (402) based on both the event type and reporting type.

In Step 4, Based on requested Event Data type, NEF (402) consolidates UE data and masks the UE identifier before exposing the information to External AF (401).

In Step 5, the NF data producer(s) (403) would provide a notification to the NEF (402) by providing the UE data at a periodicity requested or on an event occurrence indicated in the request, whichever applicable.

In Step 6, the NEF (402) shall expose this information via an event notification to the external AF (401) without including the UE identities. If in step 1, the external AF (401) requests for the reporting type to be periodic or event-based, then the steps 5 and 6 will be executed till the end condition defined by AF. The end condition could be the number of reports requested or till the end time provided.

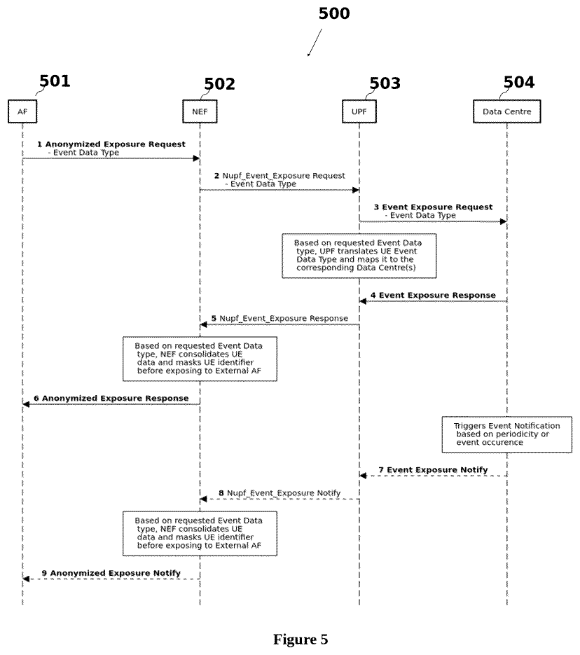

FIG. 5 depicts flow for anonymized Exposure with data collected from Data Centre(s), according to an embodiment of the present invention. The steps as illustrated below in reference to FIG. 5 provides the procedure for the anonymized exposure request from AF (501) to corresponding entity that is Data Centre (504) through NEF (502). The procedure of selection of Data Centre(s) by UPF (503) is also defined. The requested reporting type may be periodic, and event based the notification from corresponding entity is also explained.

In Step 1, the external AF (501) will request anonymized UE data mentioning the event data type by invoking Anonymized Exposure service of request NEF (502) and creates a subscription. The event trigger can be either one time, periodic or event based.

In step 2, NEF (502) translates this request and depending on the requested event data type, NEF (502) invokes the service of UPF(s) (503) and creates a subscription.

In step 3, based on requested Event Data type UPF (503) maps it to the corresponding Data Centre(s) (504) and invokes the Event Exposure Service of data centre.

In step 4, Data Centre (504) will include the UE data based on event type requested and will send response to the UPF (503).

In step 5, UPF(s) (403) will include the UE data based on event type collected from various Data Centre(s) (504) and shall send it to NEF (502).

In step 6, based on requested Event Data type, NEF (502) consolidates UE data and masks the UE identifier before exposing to External AF (501). The NEF (502) that contains the anonymized UE data shall expose this information to the external AF (501) by masking UE identities in the response. In an embodiment, if in step 1, the external AF (501) requests for the reporting type to be periodic or event-based, then the steps 7, 8 and 9 will be executed till the end condition defined by AF. The end condition could be the number of reports requested or till the end time provided.

In step 7, the Data Centre(s) (504) would provide a notification to the UPF (503) by providing the UE data at a periodic interval or based on an event occurrence, whichever applicable.

In step 8, the UPF(s) (503) would provide a notification to the NEF (502) by providing the UE data at a periodic interval or based on an event occurrence, whichever applicable.

In step 9, the NEF (502) shall expose this information via an event notification to the external AF (501) by anonymizing the UE identification information.

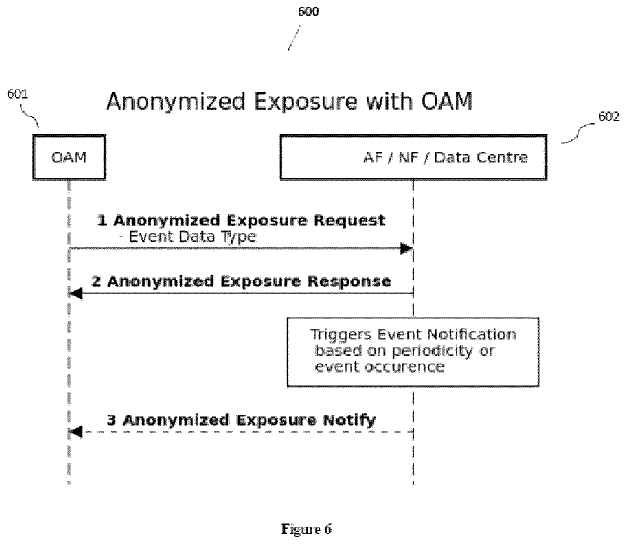

FIG. 6 depicts flow for sharing anonymized data to OAM, according to another embodiment of the present invention. The data collected in the system may also be internally used by the operator for optimizing the system resources, improving the QoS and better planning of new services etc. The steps are depicted in FIG. 6 to anonymously provide requested data to OAM (601) entity by appropriate 5GCN-NFs (602). In a further embodiment, the requested reporting type may be periodic, or event based the notification from corresponding entity. In Step 1, the OAM (601) may request for system data from appropriate entity-Internal AF or NF or Data Centre (602). In Step 2, Service providing Entity (602) may share the system data to OAM after masking the UE identities.

In a further embodiment, if in step 1, the OAM (601) requests for the reporting type to be periodic or event-based, then Step 3 is executed till the end condition defined by OAM. The end condition could be the number of reports requested or till the end time provided. In step 3, the Service providing entities (602) would provide a notification to the OAM (601) by providing the UE data at a periodic interval or based on an event occurrence, whichever applicable.

In 5G with the advent of exposure capabilities, the external AF could monetize and benefit out of the data obtained from the network. The capabilities include monitoring, provisioning, Policy/Charging, Analytics reporting etc. As of now, the exposure is limited to the AF requesting information about specific UE(s). The UE identities are present either in request from AF or as a response from the network. But this limitation acts as a bottleneck for exposing valuable information to AF which does the require the UE identity to be exposed. These events would provide clustered information/analytics and reports to AF. The NEF shares this data to subscribed and authorized External AF(s) without revealing UE identities. The solutions provided by the present invention open avenues for application providers and OAM to utilize this information for monetization, optimization and planning, public safety etc.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method for anonymized exposure of user equipment (UE) information in a communication network, the method comprises:
receiving, by a node, a first request from a service consumer for UE anonymized data containing plurality of first attributes;
selecting, by the node, at least one data producer, based on at least one attribute from the plurality of first attributes and by using a user plane entity;
sending, by the node, a second request containing the plurality of second attributes to the data producer;
receiving, by the node, from the data producer, at least one of a first response and at least one first notification containing the data of at least one UE, based on the plurality of second attributes;
processing, by the node, the data of at least one UE, based on the plurality of first attributes to generate a first report;
generating, by the node, a second report by anonymizing the UE identification information in the first report; and
sending, by the node, the second report to the service consumer, based on at least one first attribute from the plurality of first attributes.

2. The method as claimed in claim 1, wherein the second report is sent using one of a second response and at least one of a second notification.

3. The method as claimed in claim 1, processing, by the node, further comprises selecting by the node, at least one UE based on the privacy policy and subscriber permission allowing anonymized data exposure.

4. The method as claimed in claim 3, wherein the privacy policy and subscriber permission allowing anonymized data exposure of the at least one requested UE is obtained from a data repository entity in Core network.

5. The method as claimed in claim 1, wherein the node is a network exposure entity.

6. The method as claimed in claim 5, wherein the network exposure entity is a network function in the Core network.

7. The method as claimed in claim 1, wherein the service consumer is at least one external Application Function.

8. The method as claimed in claim 1, wherein the data producer is at least one of: an NF in Core network, Data Collection AF in Core network, an entity in the Radio access network (RAN), and Data Centre.

9. The method as claimed in claims 1 or 8, wherein, when a data producer in the at least one data producer is a data centre, selecting by the node is performed using the user plane entity.

10. The method as claimed in claim 1 or claim 2, wherein the first request, the second response and the second notification is sent using a service API.

11. The method as claimed in claim 10, wherein the service API is an anonymized exposure service API.

12. The method as claimed in claim 10, wherein the service API is implemented by enhancing Analytics API, Event exposure API of network exposure entity.

13. A method for anonymized exposure of user equipment (UE) information in a communication network, the method comprises:
receiving, by a data generator, a third request from a service consumer for UE anonymized data containing plurality of third attributes;
processing, by the data generator, the data of at least one UE, based on the plurality of third attributes to generate a third report;
generating, by the data generator, a fourth report by anonymizing the UE identification information in the third report; and
sending, by the data generator, the fourth report to the service consumer, based on at least one third attribute from the plurality of third attributes.

14. The method as claimed in claim 13, wherein, sending the fourth report, is performed using one of a third response and at least one of a third notification.

15. The method as claimed in claim 13, wherein the data generator comprises of NF, data collection AF in the Core network and data centre.

16. The method as claimed in claim 13, wherein the service consumer is Operations, Administration, and Maintenance entity (OAM).

17. The method as claimed in claim 13 or 14, wherein the third request, the third response and the third notification is sent using a service API.

18. The method as claimed in claims 1 or 13, wherein anonymizing the UE identification information is performed by masking identification of the UE.

19. The method as claimed in claims 1 or 13, wherein the at least one of the first attribute, the second attribute and the third attribute comprises of an event type and a reporting type.

20. The method as claimed in claim 19, wherein the attribute event type includes value from any one of: populace and Movement Trend of UEs in a specified zone or range, data Utilization Efficiency, application Usage Trends, UEs Access Split Range/Percentage, radio Resource Utilization Efficiency, QoS Utilization Efficiency, slice Utilization Efficiency, slice Load Handling Efficiency, UE Accessibility, number of dropped Connections, and thermal Energy Exposure.

21. The method as claimed in claim 19, wherein the attribute reporting type is at least one of one-time, periodic, and event-triggered.

22. A node for implementing anonymized exposure of user equipment (UE) information in a communication network, the node is configured to:
receive a first request from a service consumer for UE anonymized data containing plurality of first attributes;
select at least one data producer, based on at least one attribute from the plurality of first attributes and by using a user plane entity;
send a second request containing the plurality of second attributes to the data producer;
receive from the data producer, at least one of a first response and at least one first notification containing the data of at least one UE, based on the plurality of second attributes;
process the data of at least one UE, based on the plurality of first attributes to generate a first report;
generate a second report by anonymizing the UE identification information in the first report; and
send the second report to the service consumer, based on at least one first attribute from the plurality of first attributes.

23. The node as claimed in claim 22, wherein the node is configured to send the second report using one of a second response and at least one of a second notification.

24. The method as claimed in claim 22, wherein the node is further configured to select at least one UE based on the privacy policy and subscriber permission allowing anonymized data exposure.

25. The node as claimed in claim 24, wherein the node is configured to obtain the privacy policy and subscriber permission allowing anonymized data exposure of the at least one requested UE from a data repository entity in Core network.

26. The node as claimed in claim 22, wherein the node is a network exposure entity.

27. The node as claimed in claim 26, wherein the network exposure entity is a network function in the Core network.

28. The node as claimed in claim 22, wherein the service consumer is at least one external Application Function.

29. The node as claimed in claim 22, wherein the data producer is at least one of: an NF in Core network, Data Collection AF in Core network, an entity in the Radio access network (RAN), and Data Centre.

30. The node as claimed in claims 22 or 29, wherein the node is further configured to use the user plane entity to select data producer, when a data producer in the at least one data producer is the data centre.

31. The node as claimed in claims 22 or 23, wherein the first request, the second response and the second notification is sent using a service API.

32. The node as claimed in claim 31, wherein the service API is an anonymized exposure service API.

33. The node as claimed in claim 31, wherein the service API is implemented by enhancing Analytics API, Event exposure API of network exposure entity.

34. A node for implementing anonymized exposure of user equipment (UE) information in a communication network, the node is configured to:
receive a third request from a service consumer for UE anonymized data containing plurality of third attributes;
process the data of at least one UE, based on the plurality of third attributes to generate a third report;
generate a fourth report by anonymizing the UE identification information in the third report; and
send the fourth report to the service consumer, based on at least one third attribute from the plurality of third attributes.

35. The node as claimed in claim 34, wherein the node is configured to send the fourth report to the service consumer using one of a third response and at least one of a third notification.

36. The node as claimed in claim 34, wherein the node is a data generator.

37. The node as claimed in claim 36, wherein the data generator comprises of NF, data collection AF in the Core network and data centre.

38. The node as claimed in claim 34, wherein the service consumer is Operations, Administration, and Maintenance entity (OAM).

39. The node as claimed in claims 34 or 35, wherein the node is configured to send the third request, the third response and the third notification using a service API.

40. The node as claimed in claims 22 or 34, wherein anonymizing the UE identification information is performed by masking identification of the UE.

41. The node as claimed in claim 34, wherein the third attribute comprises of an event type and a reporting type.

42. The node as claimed in claim 40, wherein the attribute event type includes value from any one of: populace and Movement Trend of UEs in a specified zone or range, data Utilization Efficiency, application Usage Trends, UEs Access Split Range/Percentage, radio Resource Utilization Efficiency, QoS Utilization Efficiency, slice Utilization Efficiency, slice Load Handling Efficiency, UE Accessibility, number of dropped Connections, and thermal Energy Exposure.

43. The node as claimed in claim 40, wherein the attribute reporting type is at least one of one-time, periodic, and event-triggered.
